(19) United States
(12) Patent Application Publication
(10) Pub. No.: US 2009/0037735 A1
(43) Pub. Date: Feb. 5, 2009

(54) METHOD AND SYSTEM FOR DELIVERING SECURE MESSAGES TO A COMPUTER DESKTOP

(76) Inventors: David O'Farrell, Whitby (CA); Cuneyt Karul, Toronto (CA); Michael Vamvakaris, Toronto (CA)

Correspondence Address: BENNETT JONES LLP, 3400 ONE FIRST CANADIAN PLACE, PO BOX 130, TORONTO, ON, M5X 1A4, CA

(21) Appl. No.: 11/832,543

(22) Filed: Aug. 1, 2007

(51) Int. Cl. H04L 9/00

(52) U.S. Cl. 713/170

(57) ABSTRACT

A system and method for delivering a secure message to the desktop of a computer for a user. The system comprises polling a server to determine if any messages are waiting for the user. The polling includes providing and authenticating security credentials associated with the user. If a message is waiting on the server, a notification is generated on the computer of the user. A portion of the message may be delivered to the desktop as part of the notification. The message is encrypted with a public-private key pair associated with the user and delivered to the desktop of the computer. The communication link between the computer and the server may comprise a secure channel.

### FIELD OF THE INVENTION

The present invention relates to computer systems and more particularly, to a method and system for delivering secure messages to the desktop of a computer.

### BACKGROUND OF THE INVENTION

The use of email is pervasive in both the corporate world and also personal life. Notwithstanding the popularity and in many cases dependence on email communication, conventional email remains an insecure communication medium and is susceptible to interception and/or eavesdropping. Email is also a commonly used technique for “phishing” for confidential information.

In view of the shortcomings associated with email, in particular, the lack of security, many enterprises, such as financial institutions, have instituted policies forbidding the transfer of sensitive information and/or confidential documents (i.e. attachments) via email. An unfortunate side effect of such policies is that regular mail or courier delivery of the confidential documents is required to deliver the documents to the intended recipients, for example, clients of a bank or a brokerage. Not only is this a more costly delivery mechanism, it does not have the inherent speed and efficiency of electronic communication.

Accordingly, there remains a need for improvements in the art for the electronic delivery of secure messages containing confidential documents and/or sensitive information to the computer of a client or customer.

### SUMMARY OF THE INVENTION

The present invention provides a method and system for delivering secure documents, for example, to a computer desktop.

According to one aspect, the present invention provides a mechanism for delivering a secure message to the desktop of a computer, the mechanism comprises: polling means for determining if a secure message is waiting for a user associated with the computer; means responsive to the polling means for generating a notification for the user if a secure message is waiting; means responsive to an input from the user for delivering the secure message to the desktop of the computer in a form that is readable by the user.

According to another aspect, the present invention provides a method for delivering a secure message to a desktop of a computer associated with a user, the method comprises the steps of: polling a server to determine if one or more secure messages are waiting for the user; generating a notification for the user on the desktop of the computer if one or more secure messages are waiting for the user; delivering at least a portion of the one or more secure messages to the desktop of the computer.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form an exemplary system incorporating a secure document delivery mechanism according to an embodiment of the invention;

FIG. 2 shows in schematic form the flow of data during a registration process according to an embodiment of the invention;

FIG. 3 shows in schematic form the flow of data during a polling process according to an embodiment of the invention;

FIG. 4 shows in schematic form the flow of data during a download process according to an embodiment of the invention;

FIG. 5(a) is a screenshot of an exemplary Logon screen according to an embodiment of the invention;

FIG. 5(b) is a screenshot of an exemplary Announcement screen according to an embodiment of the invention;

FIG. 5(c) is a screenshot of an exemplary Download/Install screen according to an embodiment of the invention;

FIG. 5(d) is a screenshot of an exemplary Installer screen according to an embodiment of the invention;

FIG. 5(e) is a screenshot of an exemplary software licence and services agreement screen according to an embodiment of the invention;

FIG. 5(f) is a screenshot of an exemplary Security warning screen according to an embodiment of the invention;

FIG. 5(g) is a screenshot of an exemplary Setup Status screen according to an embodiment of the invention;

FIG. 5(h) is a screenshot of an exemplary Setup Complete screen according to an embodiment of the invention;

FIG. 5(i) is a screenshot of an exemplary Activation Wizard screen according to an embodiment of the invention;

FIG. 5(j) is a screenshot of an exemplary Enter Activation Code screen for the activation wizard according to an embodiment of the invention;

FIG. 5(k) is a screenshot of an exemplary Alert Preferences screen for the activation wizard according to an embodiment of the invention;

FIG. 5(l) is a screenshot of an exemplary Create Password screen for the activation wizard according to an embodiment of the invention;

FIG. 5(m) is a screenshot of an exemplary Challenge Questions screen for the activation wizard according to an embodiment of the invention;

FIG. 5(n) is a screenshot of an exemplary Security Image screen for the activation wizard according to an embodiment of the invention;

FIG. 5(o) is a screenshot of an exemplary Activation Completed screen for the activation wizard according to an embodiment of the invention;

FIG. 6(a) is a screenshot of an exemplary Secure Alert or notification pop-up window according to an embodiment of the invention;

FIG. 6(b) is a screenshot of an exemplary Enter Password screen according to an embodiment of the invention;

FIG. 6(c) is a screenshot of an exemplary Secure Reader screen according to an embodiment of the invention;

FIG. 6(d) is a screenshot of an exemplary Compose Reply screen according to an embodiment of the invention;

FIG. 6(e) is a screenshot of an exemplary Secure Alert or notification pop-up window according to another aspect of the invention; and

FIG. 6(f) is a screenshot of an exemplary Secure Alerts screen according to an embodiment of the invention.

Like reference numerals indicate like or corresponding elements or components in the drawings.

### DETAILED DESCRIPTION OF THE EMBODIMENTS OF THE INVENTION

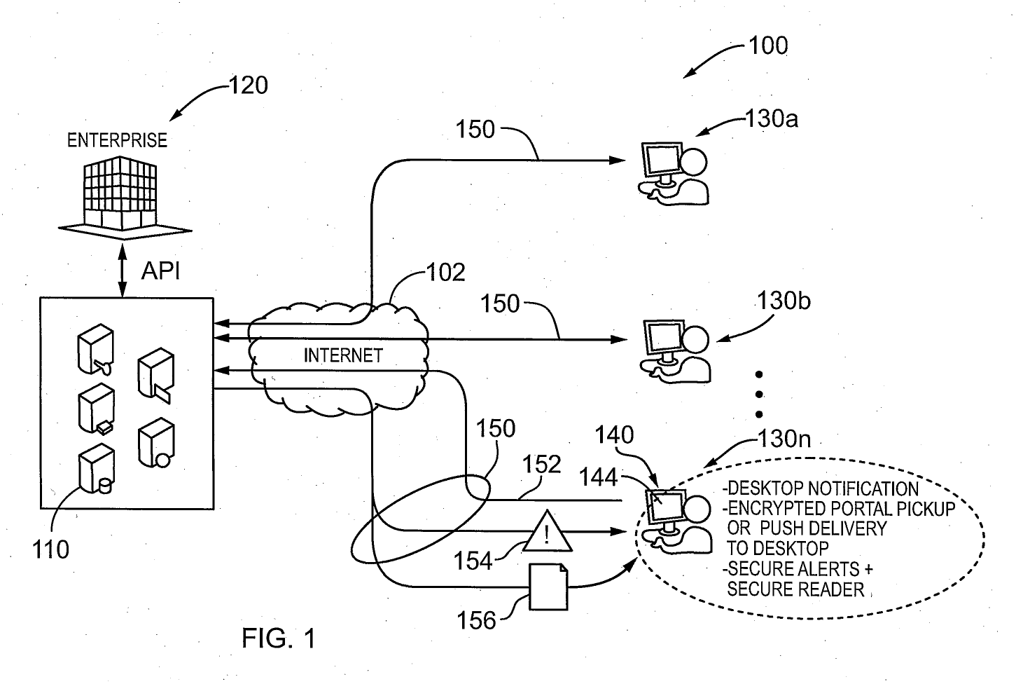

Reference is made to FIG. 1, which shows in diagrammatic form an exemplary system 100 for implementing and practising a method and system for delivering secure messages (i.e. confidential information and/or documents) to a desktop on a computer according to an embodiment of the present invention. As shown in FIG. 1, the exemplary system 100 comprises a secure server 110, an enterprise 120 and customers or clients 130. The customers or clients 130 are associated with the enterprise 120 and are indicated individually by reference 130a, 130b . . . 130n. For the embodiment depicted in FIG. 1, the clients 130 are connected via the Internet indicated generally by reference 102. It will be appreciated that the method and system according to the present invention may be practised or implemented for other networks and/or configurations.

According to an exemplary embodiment, the enterprise 120 comprises a bank or other financial institution and the clients 130 comprise customers, i.e. account holders, of the bank. Each of the customers 130 have a computer 140 and the computer 140 runs a desktop appliance or agent indicated generally by reference 144. The desktop agent 140 is implemented in computer code, for example, as an application program interface or API, which according to an embodiment is configured to run on a “desktop”, e.g. on “Taskbar” or “Tray” for a Windows™ based operating system running on the computer 140. The desktop agent 144 provides the functionality such as establishing a secure connection and receiving a secure document on the computer desktop, as described in more detail below. According to an embodiment, the method and system provides multiple layers or levels of security, including channel security with the desktop agent 140, encrypted or secured client objects, and encrypted or secured payloads.

According to an embodiment, each of the clients/customers 130 (i.e. users) is coupled to the secure server 110 via a communication link (e.g. a channel) established via the Internet 102. The communication link or channel is indicated generally by reference 150. According to one embodiment, the channel 150 provides bidirectional communication between the desktop agent 144 (i.e. application) running on the computer 140 associated with the client 130. The bidirectional communication comprises a status update request 152, a notification or alert message 154 and/or a secure document transfer 156. The status update 152 may comprise a polling request or operation which originates from the desktop agent 144 as described in more detail below. The notification or alert message 154 notifies the client 130 that a secure message and/or document are awaiting delivery from the enterprise 120 via the secure server 110. The client 130 may access the document via a secure/encrypted portal for the enterprise 120 or have the document delivered or pushed to the desktop agent 144 as an encrypted or otherwise secured payload 156, as will be described in more detail below. According to an embodiment, the communication link 150 comprises a secure or encrypted channel.

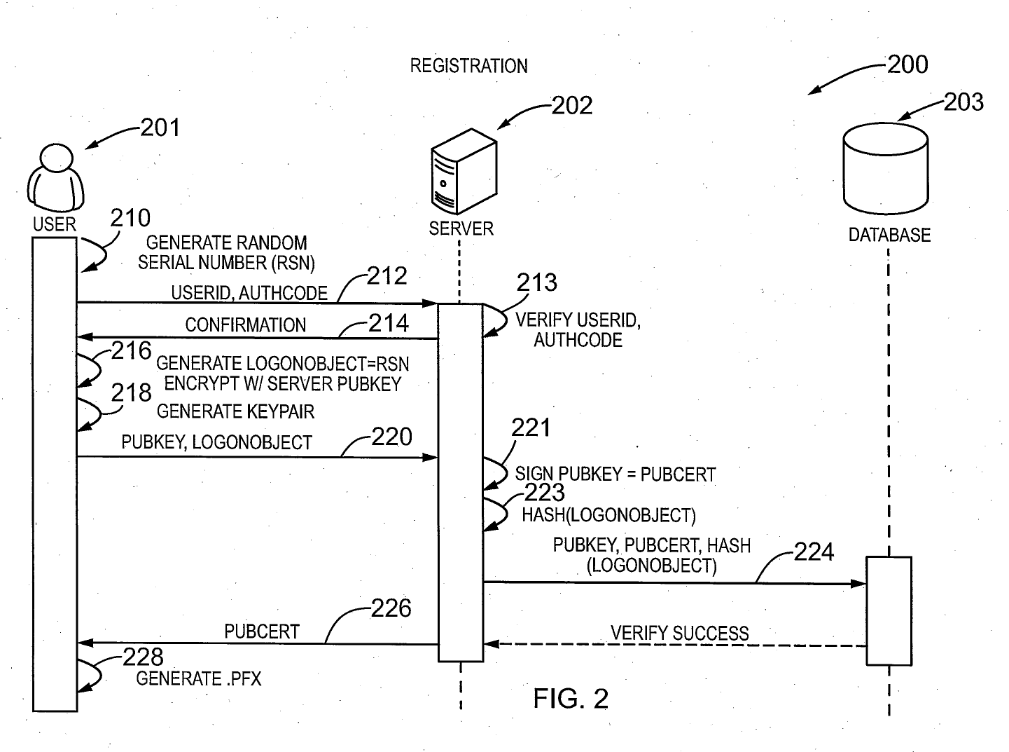

Reference is made to FIG. 2, which shows in schematic form the flow of data during a registration process according to an embodiment of the invention. The registration process is indicated generally by reference 200. The registration process 200 is implemented in software (e.g. in the form of one or more software computer programs, objects, modules or components) on the server and running on the user's computer to provide the functionality as described in more detail below. The particular implementation details for the software will be within the understanding of one skilled in the art.

In FIG. 2, the user is indicated by reference 201 and the secure server is denoted by 202. The secure server 202 is coupled to a database indicated by reference 203. The database 203 serves as a repository for secure information, such as user credentials, secure documents and messages. Prior to initiating the registration process 200, the user (e.g. client or customer 130) installs an application, i.e. the desktop agent 144, on his or her computer 140. For instance, the application may be downloaded from the enterprise 120 and installed on the user's computer 140. Once the application is installed, the user 201 can commence the registration process 200, i.e. the user 201 opens a registration session with the server 202. As shown in FIG. 2, a random serial number or RSN is generated as indicated by 210. The user 201 enters a user identifier (UserID) and an activation or authorization code (AuthCode) in order to initiate the registration process with the server 202 as indicated by 212. The user 201 may also generate a serialized tokenID, for example, by encrypting the RSN with a public key obtained from the server 202. The server 202 verifies (i.e. authenticates) the UserID and AuthCode received from the user 201 as indicated by 213, and sends a confirmation message as indicated by 214. If the authentication process is successful, then according to one embodiment, the server 202 stores a 1-way hash of the serialized tokenID in the database 203 together with the UserID. The application (i.e. client) stores the serialized tokenID and UserID in a config file. If the authentication or verification process fails, the user is presented with an error message or alert and asked to re-enter the UserID and the activation code and repeat the registration process 200 at 212. The application generates a LogonObject. The LogonObject allows the user to securely log on to the enterprise as will be described in more detail below. According to one embodiment, the LogonObject is generated by encrypting the RSN with a public key obtained from the server 201 (i.e. the serialized tokenID), as indicated by 216. Next at 218, the user begins the key generation process. According to one embodiment, a PKCS10 certificate signing request is generated and the UserID used in registration is imported. The user provides a password and selects/answers one or more password recovery (e.g. “challenge”) questions. According to another aspect, a RecoveryObject is formed by encrypting the password provided by the user with an encryption key which is generated based on a hash of the sum of the answers to the recovery questions using a known algorithm such as AES. The user's PKCS10 certificate signing request (i.e. PubKey) is sent to the server 202 for signing as indicated in 220. According to an embodiment, the LogonObject (i.e. the serialized tokenID) is also transmitted to the server 202 for recovery purposes, i.e. a hash of the user's password is generated (as indicated by 223) and stored in the secure database 203 (as indicated by 224). The server 202 receives the PKCS10 certificate signing request (i.e. the PubKey) from the user and passes it to a Certification Authority PKI infrastructure to receive a signed certificate, i.e. PubCert, as indicated by 221. The server 202 stores a copy of the signed certificate (PubCert) in the database 203 as indicated by 224. The signed certificate (PubCert) is used by the server 202 for encrypting files (e.g. messages and documents) from the enterprise to the client. A copy of the signed certificate (PubCert) is returned to the user (i.e. the application) as indicated by 226. The application receives the signed certificate and stores the certificate and user keys locally, for example, by building a PKCS12 container for a local certificate repository.

According to another embodiment, the keys for the user are generated on the server 202 and transmitted back to the application for storing in the local certificate repository.

According to another embodiment, the keys for the user may be linked to the user's existing profile for password synchronization.

According to another embodiment, the keys and/or password for the user may be escrowed and stored for recovery by the user and/or a quorum of individuals.

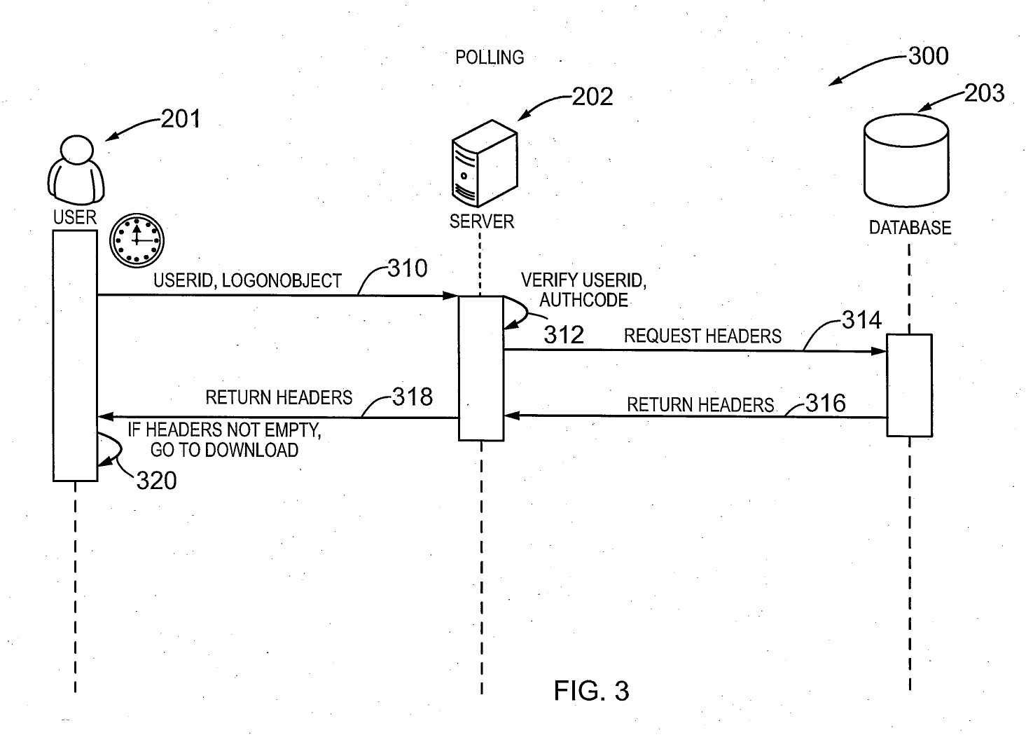

Reference is next made to FIG. 3, which shows in schematic form data flow for a polling process according to an embodiment of the invention. According to one embodiment, the application (i.e. the desktop agent 144) polls the server 202 periodically to determine if a secure message or secure document is waiting to be delivered to the user 201. According to an embodiment, the polling operation is performed at regular intervals and comprises the application first checking for an Internet connection. If an Internet connection is present, then the application connects to the server 110 (FIG. 1) over a secure (i.e. encrypted) channel 150 (FIG. 1), and sends the client's UserID and LogonObject. As described above, the LogonObject may comprise a serialized tokenID. The server 202 hashes the serialized tokenID and compares it to the value stored in the secure database 203 (FIG. 2). If the serialized tokenID does not match the value stored in the database 203, then the polling request is rejected. If there is a match with the serialized tokenID, then the server 202 checks for messages associated with the client. According to one embodiment, the server 202 checks for message headers. If there are message(s) available, the server 202 transmits the message header(s) back to the application in a notification message 154 (FIG. 1) over the secure channel 150. If there are no messages for the client, then the server 202 returns no message headers and a notification 154 is not generated for the application.

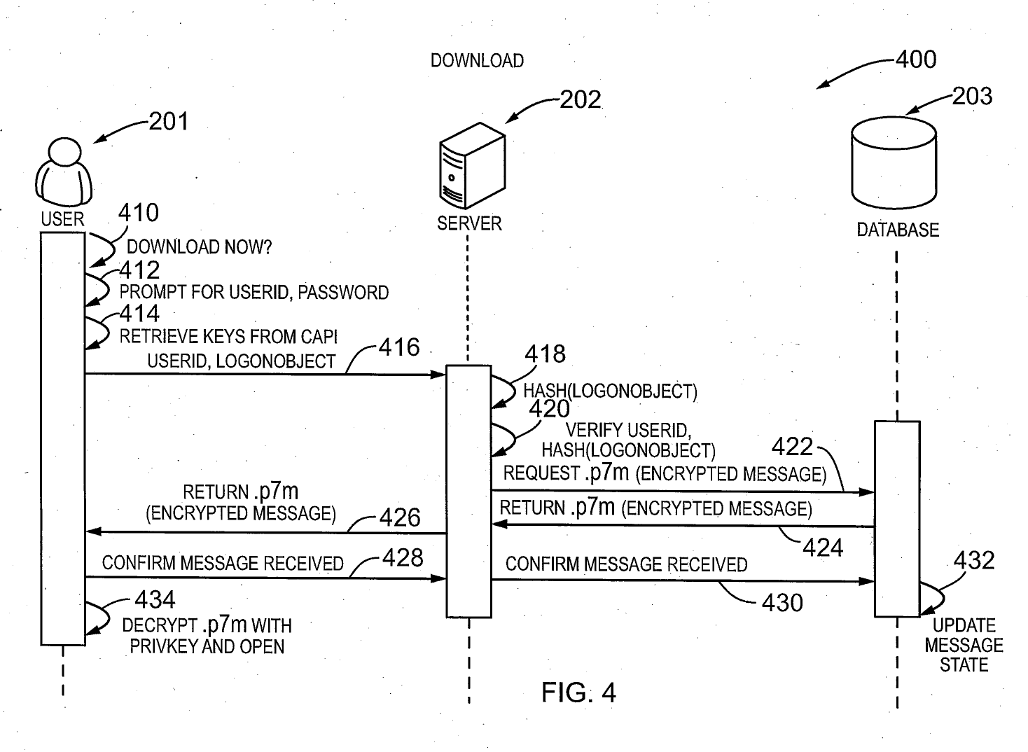

Reference is next made to FIG. 4, which shows in schematic form data flow for a process for downloading a secure message or document according to an embodiment of the invention. The download process is indicated generally by reference 400. The download process 400 may be invoked or initiated by the application (i.e. the user 201) as indicated by reference 410, for example, in response to receiving a message waiting notification 154 as described above. The user 201 (i.e. client) is prompted to authenticate, which according to an embodiment comprises providing the UserID and Password. The application retrieves the credential file (e.g. PFX file) associated with the user 201 from the local certificate repository, as indicated by reference 414, and the user's (i.e. client's) UserID and Password are checked. If the user (i.e. client) 201 has provided the correct UserID and Password, then the application authenticates to the server 202 by transmitting the UserID and the LogonObject (i.e. serialized tokenID) over the encrypted channel 150, as indicated by reference 416 in FIG. 4. The server 202, in turn, hashes the serialized tokenID (i.e. LogonObject) in 418, and verifies the hashed LogonObject and the UserID with the values stored in the secure database 203 as indicated by 420. If the authentication of the user (i.e. client) 201 by the server 202 passes, the server 202 then proceeds to retrieve the message(s) waiting for the user 201. According to an embodiment, the message(s) are stored as encrypted files (for example, according to .P7M or another encryption technique or protocol) in the secure database 203. The server 202 issues a request to retrieve the .P7M encrypted message as indicated by 422. The encrypted message is returned as indicated by 424 and transmitted by the server 202 to the user 201 (i.e. client) as indicated by 426. Once the message is successfully received by the user 201, the application sends a message back to the server 202 confirming receipt of the message as indicated by 428. In response to the confirmation message, the server 202 sends a notification to the secure database 203, which updates the message status to reflect delivery as indicated by reference 432. According to an embodiment, the message status may be used with other statistical data to generate a log, for example, for audit purposes. Back at the computer of the user 201, the message is decrypted using for example, a public-private key pair associated with the user 201, as indicated by 434. In the context of a banking enterprise, the encrypted message may comprise a message indicating that the client's bank statement or a mortgage or loan document is available. According to an embodiment, the encrypted message may further include the bank statement or mortgage document, or alternatively a link to access a secure portal for viewing the bank statement. According to another embodiment, the bank statement is transmitted in a separate encrypted message.

It will be appreciated that according to an embodiment, security is provided at two levels. First, the message is transmitted in a secure format, e.g. as a .P7M encrypted file. Second, the encrypted file is transmitted over a secure or encrypted channel 150 (FIG. 1) between the server 110 (FIG. 1) and the application (i.e. the desktop agent 144) running on the user's computer 140 (FIG. 1).

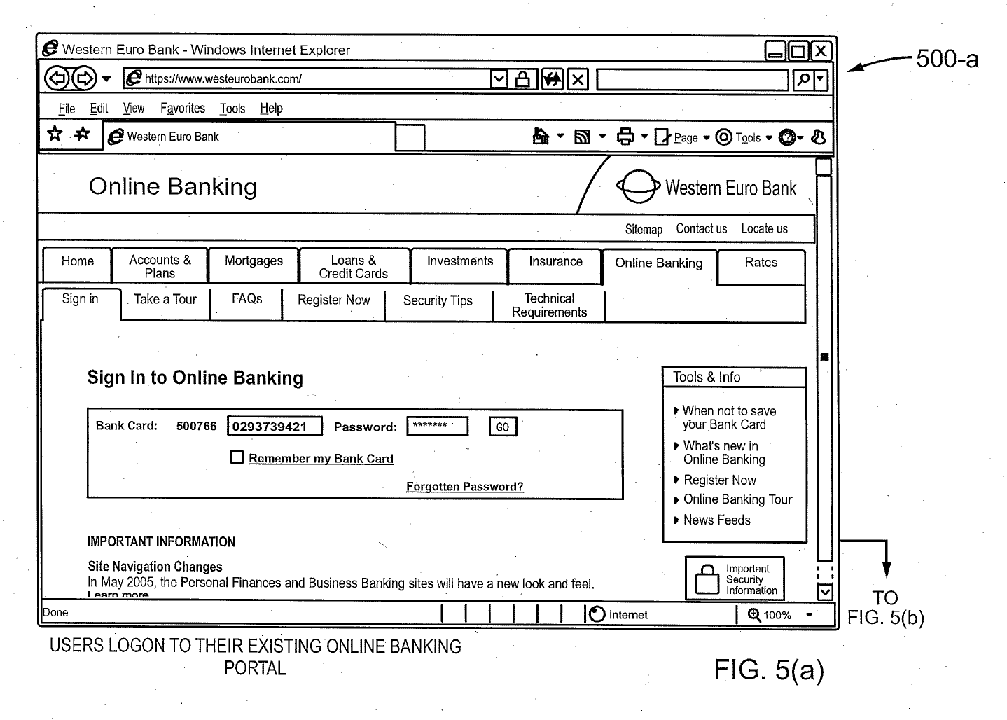

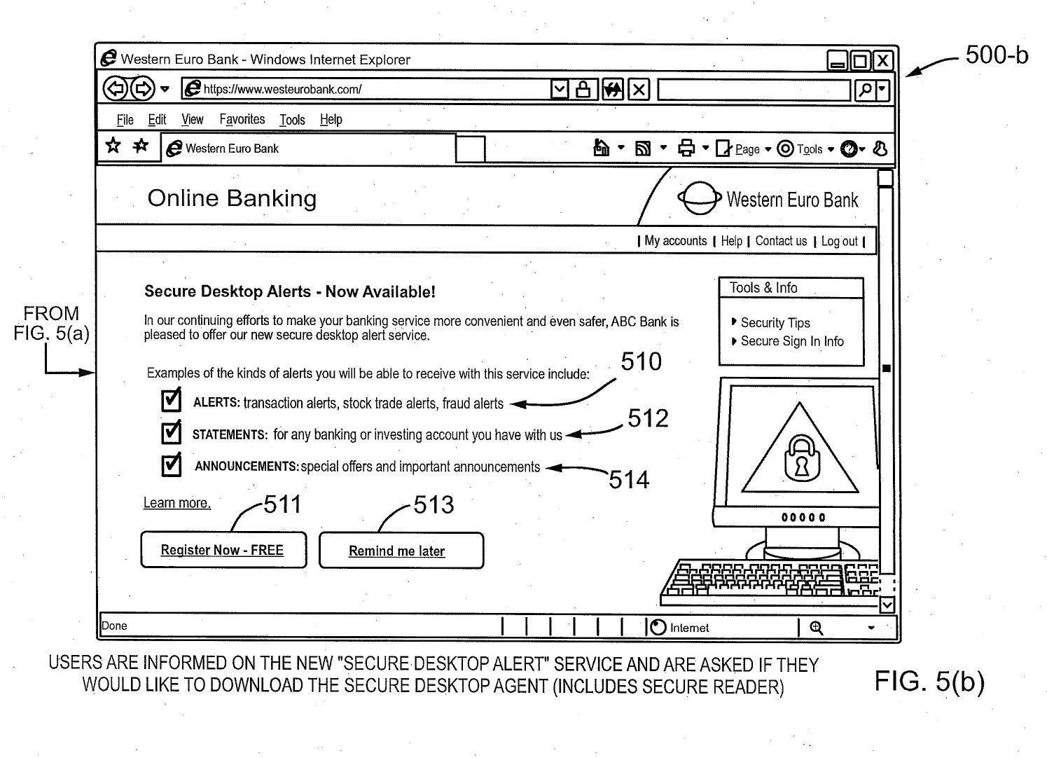

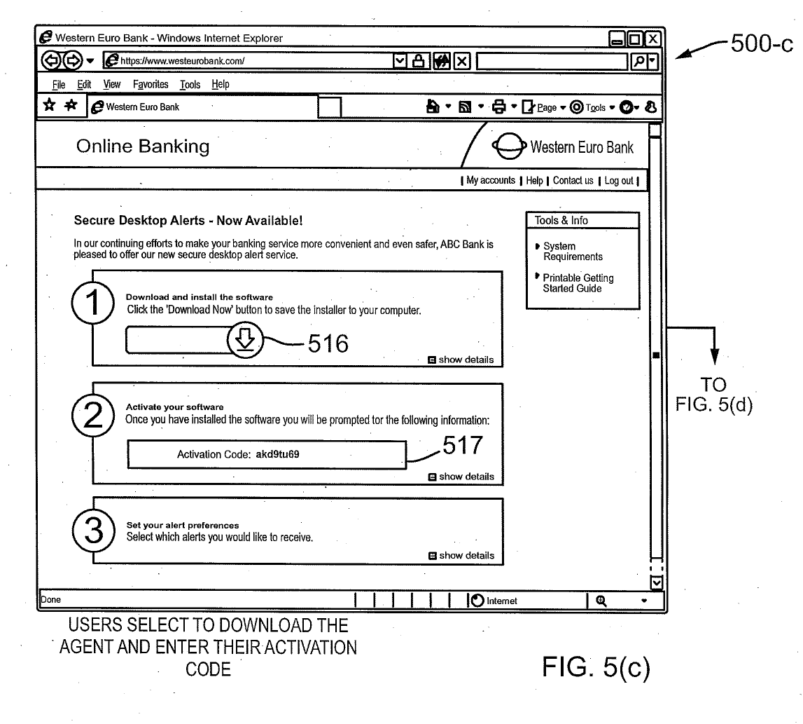

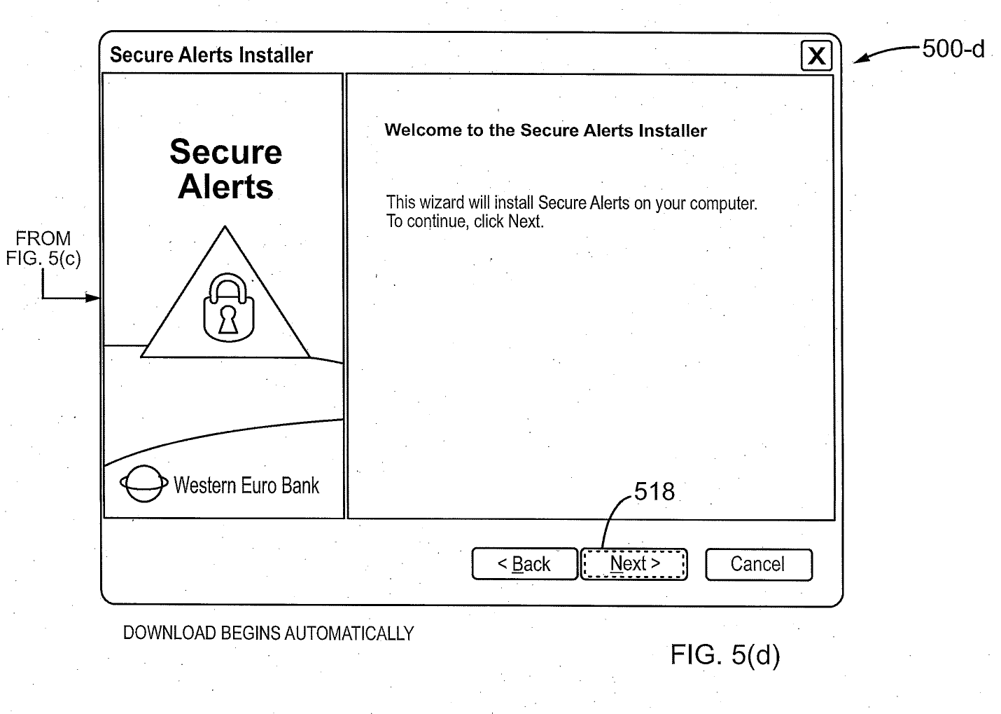

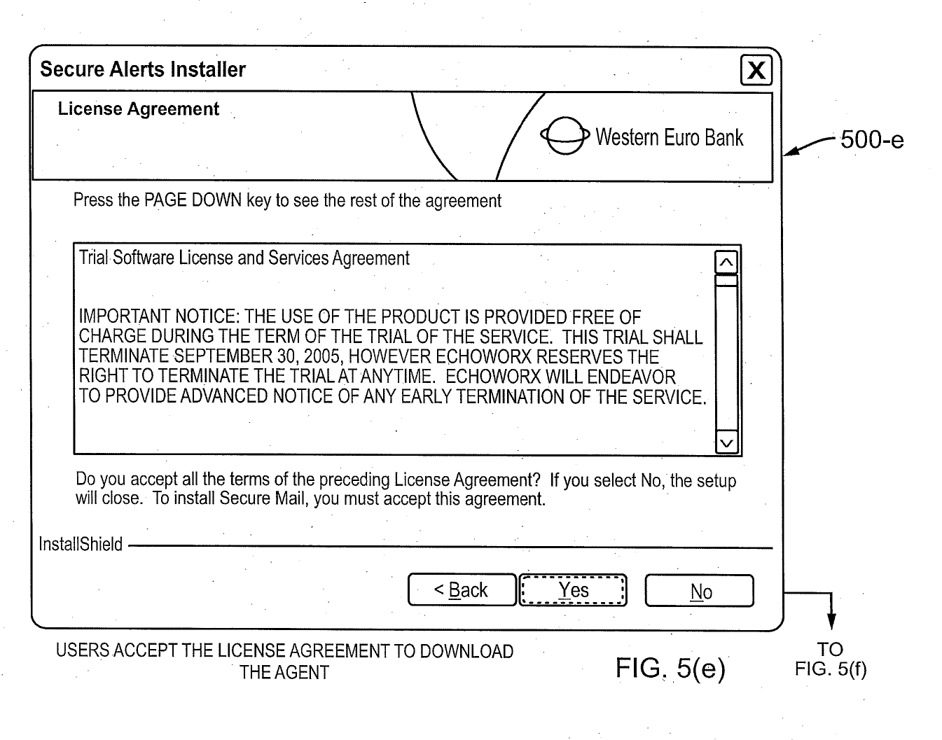

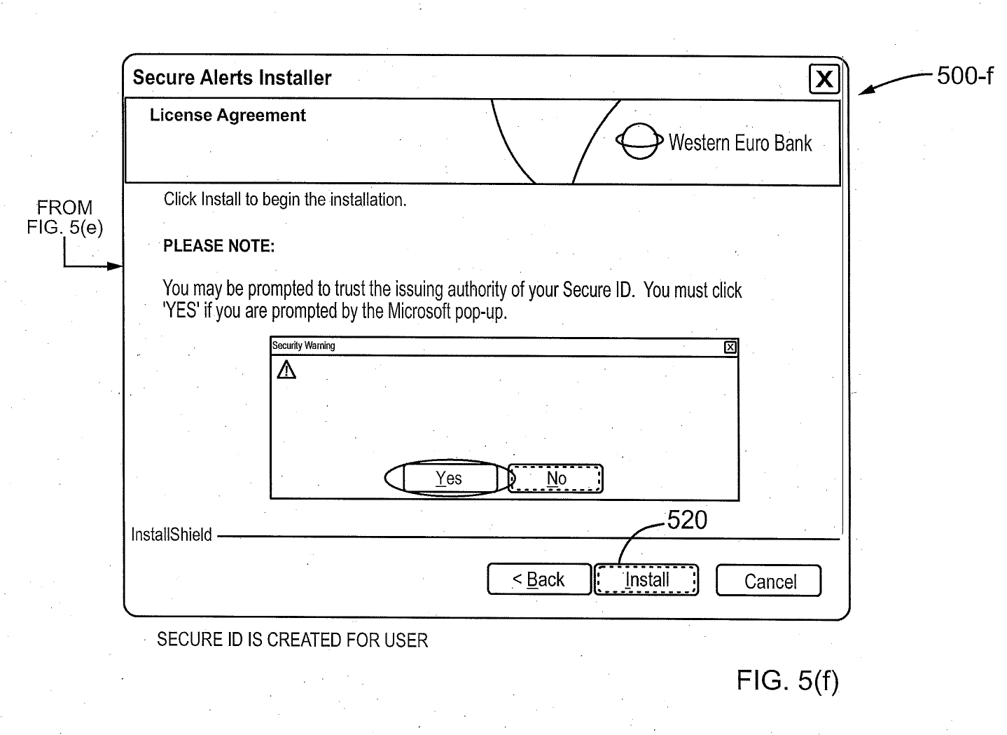

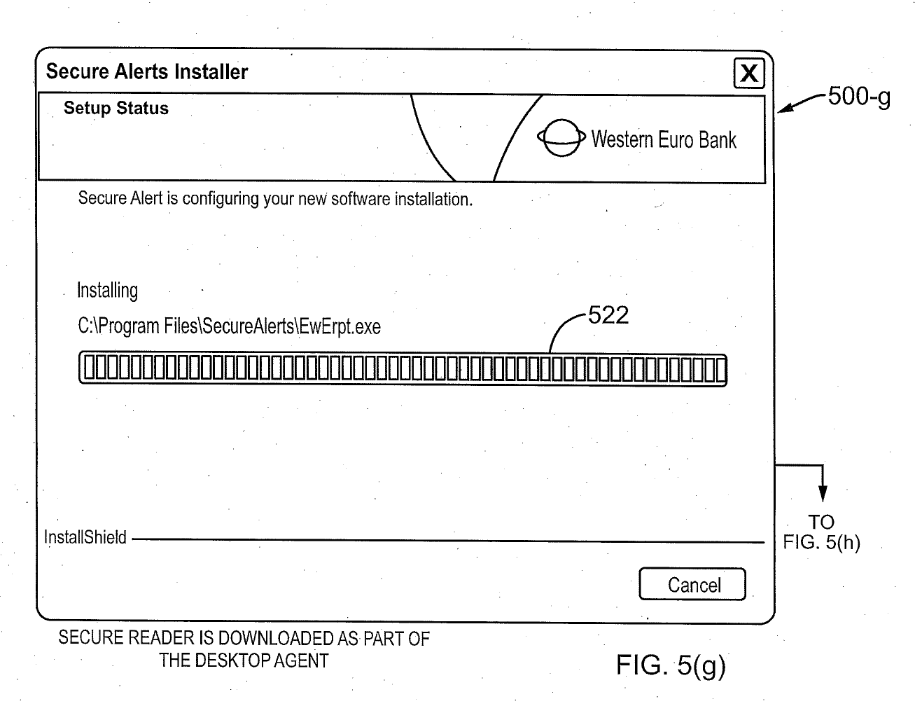

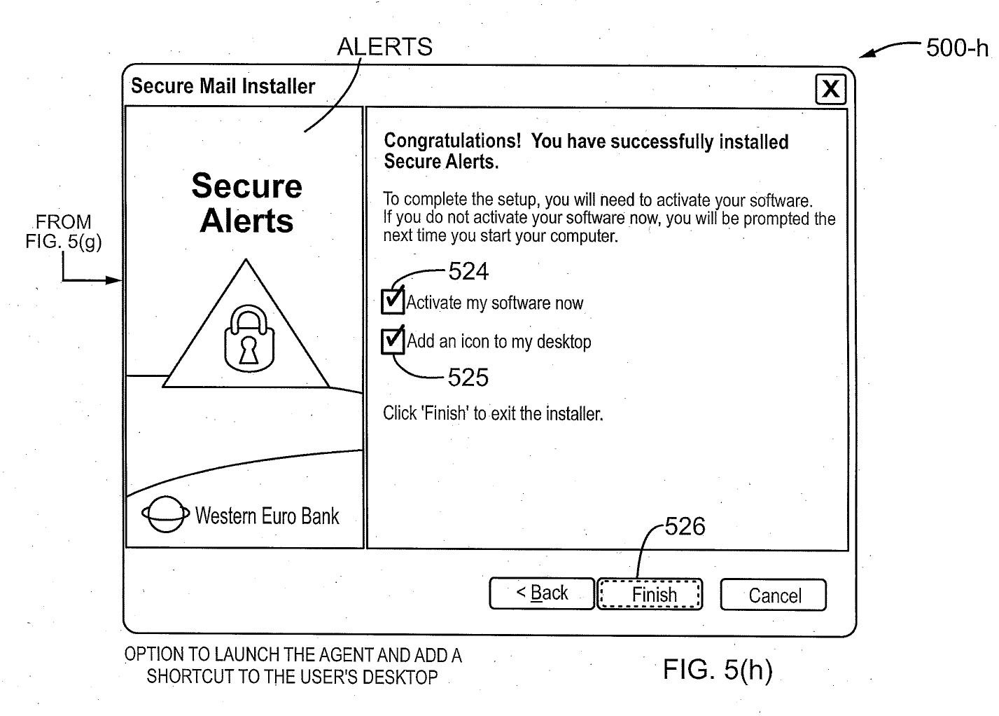

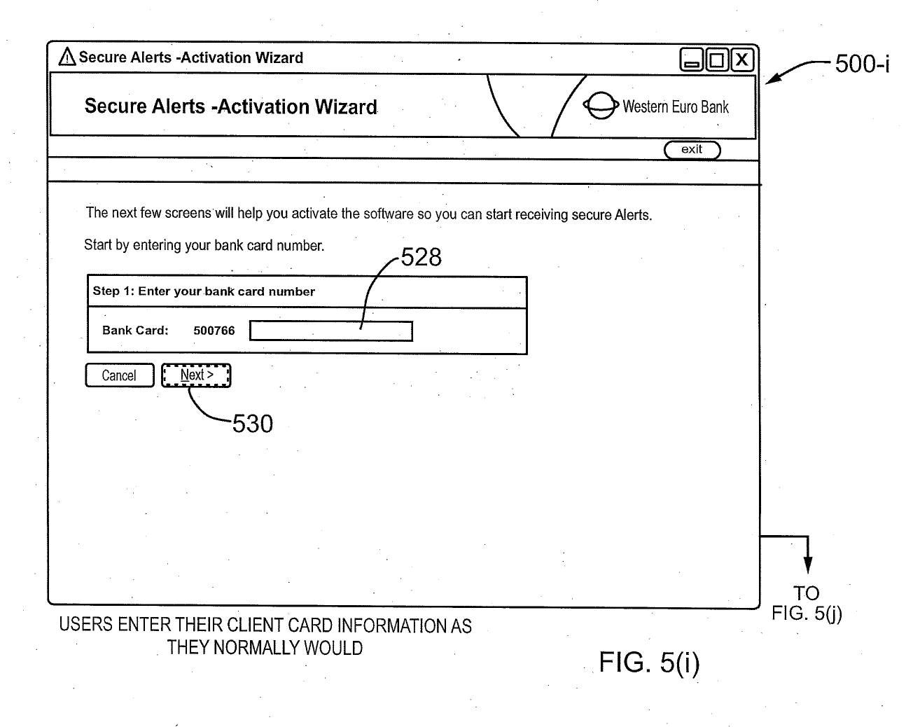

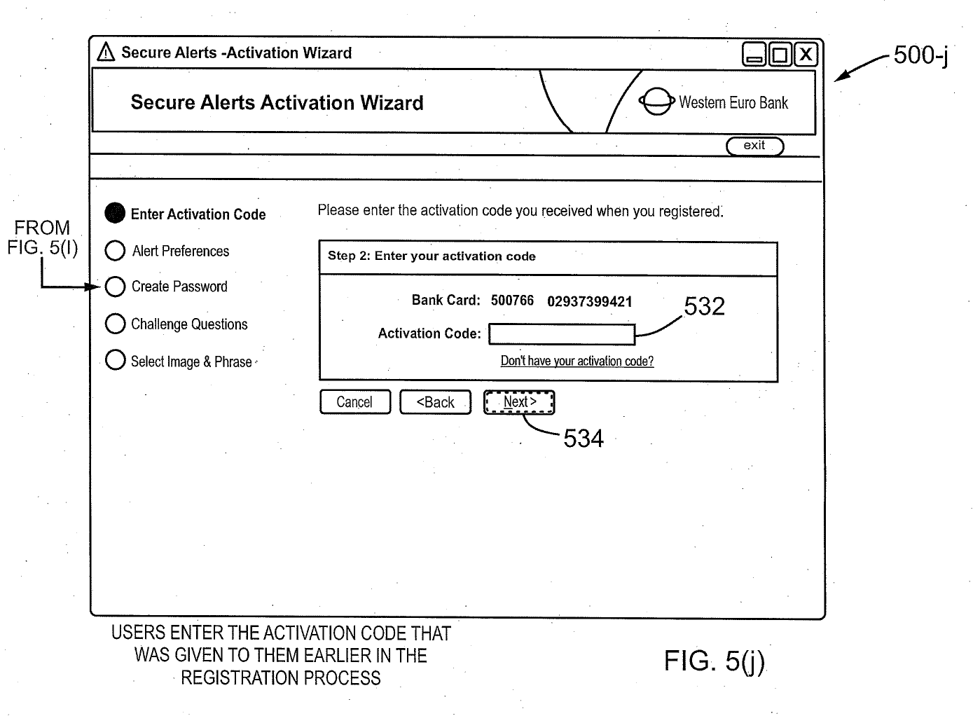

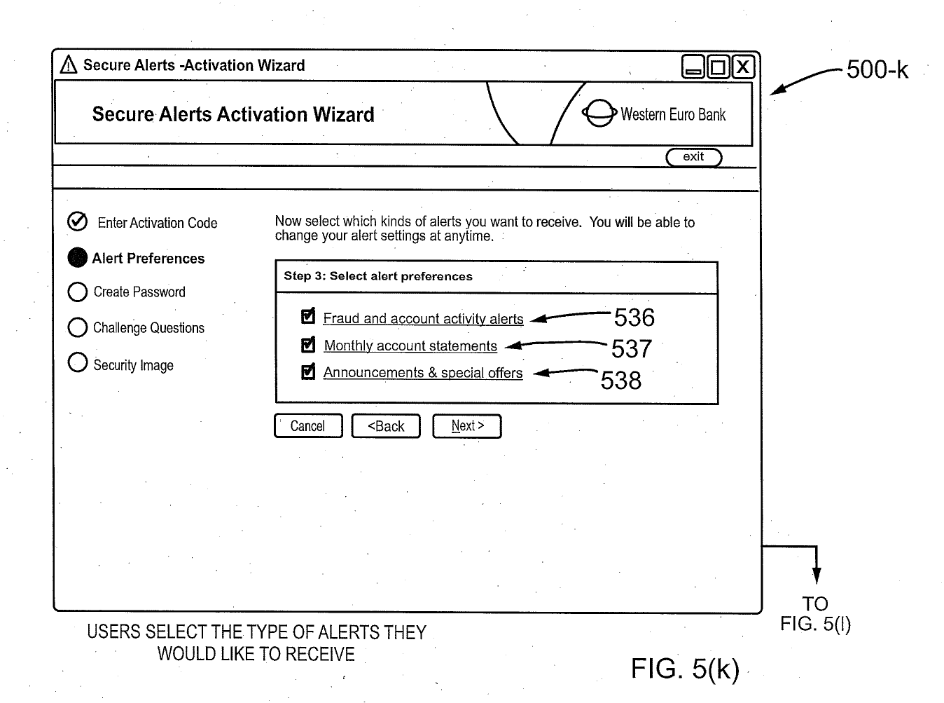

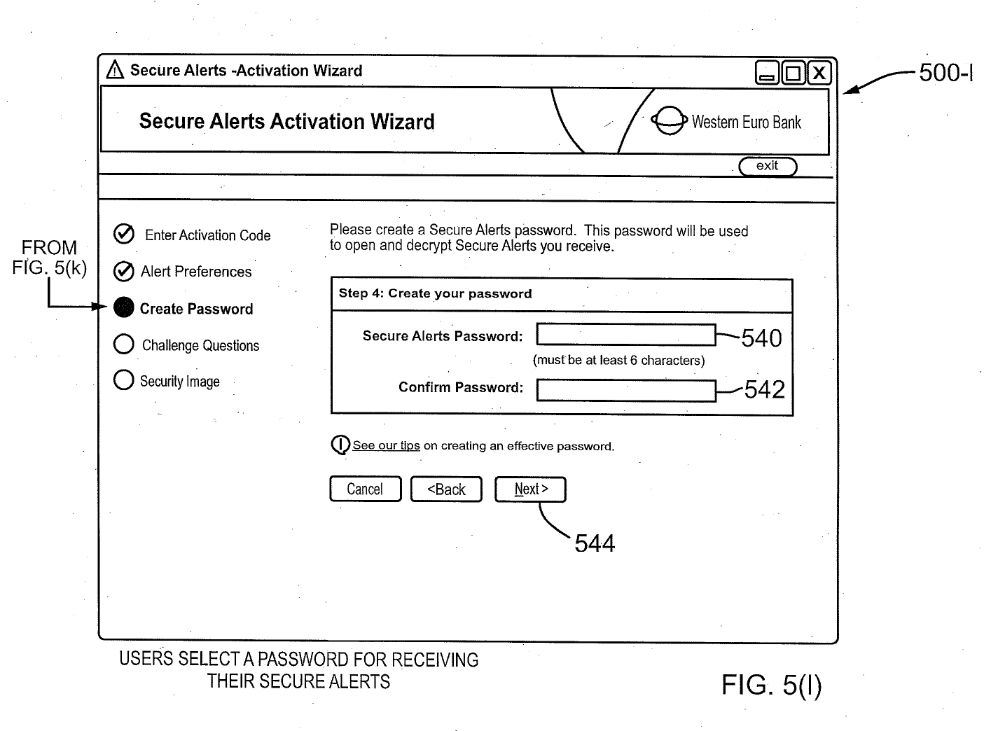

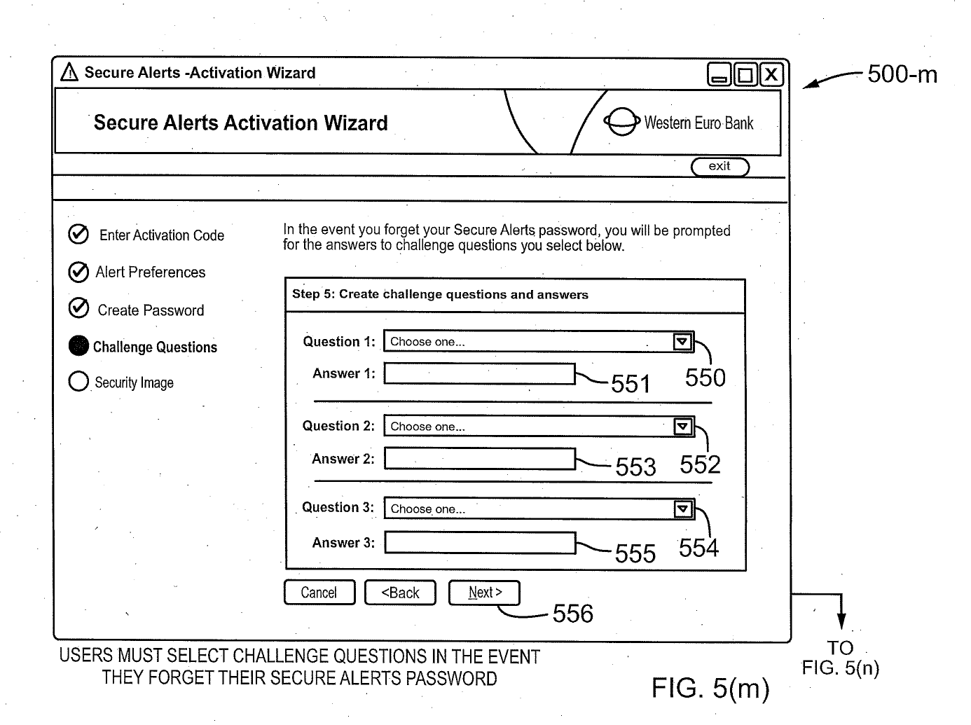

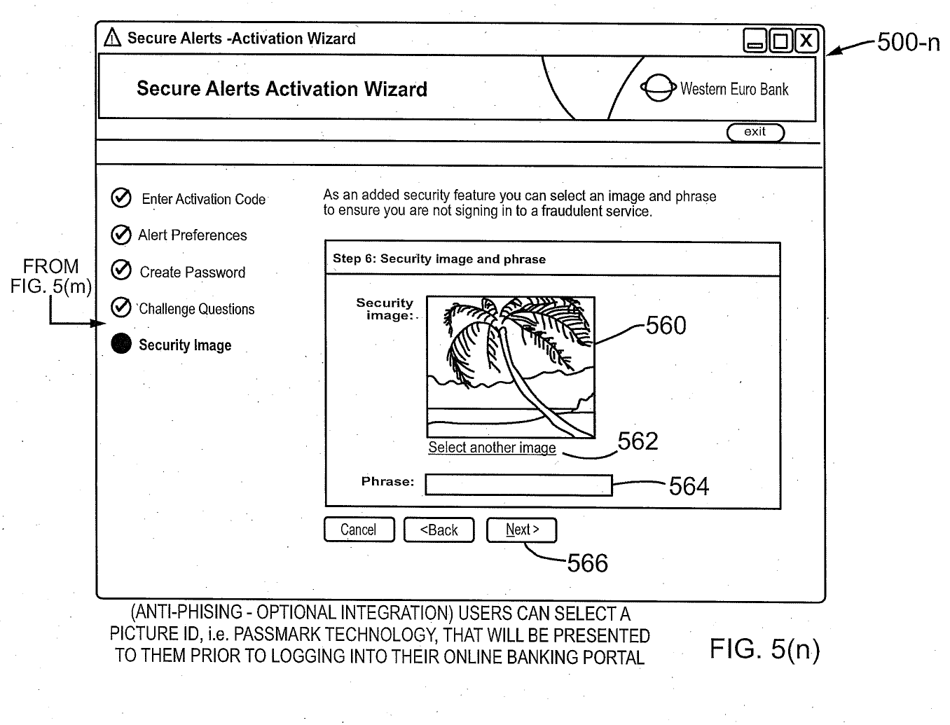

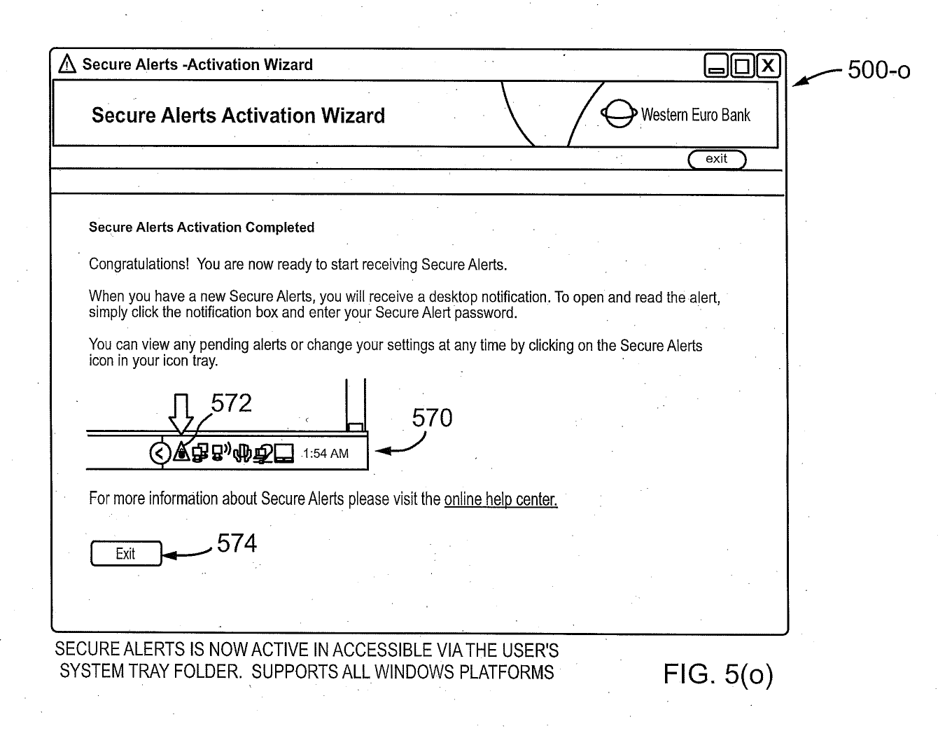

Reference is next made to the screenshots in FIGS. 5(a) to 5(o), which further show operation of the system and method according to embodiments of the present invention in the context of a financial institution application or banking enterprise. FIG. 5(a) shows a screenshot of a Logon screen 500-a, which is used by a banking client or customer to logon onto their existing online banking portal. The banking client logs on using their bank card number and password. In accordance with an embodiment, a notification informing the banking client of the secure document downloadable application (i.e. “Secure Desktop Alert”) is displayed or provided in an Announcement screen 500-b as shown in FIG. 5(b). The Announcement screen 500-b lists the types of alerts that are available with the downloadable application, including “Alerts” 510 for transaction alerts, stock trade alerts and/or fraud alerts, “Statements” 512 for banking and investing account statements, and “Announcements” 514 for special offers and important announcements. The banking client can register for the service by clicking a “Register Now” button 511 or be reminded later by clicking a “Remind me later” button 513.

If the banking client clicks the “Register Now” button 511 (FIG. 5(b)), then a Download/Install screen 500-c having a form as shown in FIG. 5(c) is displayed. Referring to FIG. 5(c), the Download/Install screen 500-c includes a Download button 516 for installing the application (i.e. the desktop agent 144 in FIG. 1). According to one embodiment, the desktop agent 144 is installed using an installer application having a screen 500-d of the form shown in FIG. 5(d). As shown in FIG. 5(c), the Download/Installer screen 500-c also provides the banking client with an Activation Code 517. The Activation Code 517 corresponds to the authorization code described above with reference to the registration process 200 in FIG. 2.

Referring to FIG. 5(d), the Installer screen 500-d includes a “Next” button 518 and clicking the Next button 518 begins the downloading of the software for the desktop agent 144. As part of the download process, a software licence and services agreement screen 500-e having a form as shown in FIG. 5(e) may be displayed and require completion for the download process to continue. Next a Security ID screen 500-f having a form as shown in FIG. 5(f) is displayed. The Security ID screen 500-f includes an “Install” button 520. To proceed with the download/installation of the software for the desktop agent 144, the banking client clicks the Install button 520 and the software continues to download as indicated by an Installing screen 500-g having a form for example as shown in FIG. 5(g). The Installing screen 500-g includes a download status indicator box 522. To complete the installation of the software, a Setup Complete screen 500-h having a form as shown in FIG. 5(h) is displayed. The Setup Complete screen 500-h includes an Activate checkbox 524, an Add icon checkbox 525 and a Finish button 526. The checkboxes 524, 525 give the banking client the option to launch the desktop agent and/or add a shortcut to the desktop of the banking client's computer.

To activate the desktop agent, an activation wizard is started which displays an Activation screen 500-i having a form as shown in FIG. 5(i). The Activation screen 500-i prompts the banking client to enter his or her bank card number in an input box 528, and then click a “Next” button 530. In response to clicking the Next button 530, the activation wizard displays an Enter Activation Code screen 500-j having a form as shown in FIG. 5(j). In the Enter Activation Code screen 500-j, the banking client is prompted to enter the activation code in an input field 532. (The activation code is obtained as described above with reference to FIG. 5(c).) The banking client clicks a “Next” button 534 and an Alert Preferences screen 500-k having a form as shown in FIG. 5(k) is displayed. The Alert Preferences screen 500-k allows the banking client to select preferences associated with the desktop agent. According to an embodiment, the Alert Preferences screen 500-k includes a checkbox 536 for receiving fraud and account activity alerts, a checkbox 537 for receiving monthly account statements, and a checkbox 538 for receiving announcements and special offers. Clicking a “Finish” button 539 on the Alert Preferences screen 500-k causes the activation wizard to display a Create Password screen 500-l having a form as shown in FIG. 5(l). The Create Password screen 500-l prompts the banking client to enter a password for the desktop agent in an input box 540 and confirm the password by re-entering it in another input box 542. As described above with reference to FIG. 4, the password is used by the user (i.e. banking client) to retrieve secure messages and/or documents using the application. In response to the banking client clicking a “Next” button 544, the activation wizard creates a password and displays a Challenge Questions screen 500-m having a form as shown in FIG. 5(m).

Referring to FIG. 5(m), the Challenge Questions screen 500-m allows a banking client to select one or more questions and enter answers to the selected questions. The questions and answers are used to recover the banking client's password in the event the client cannot remember it, e.g. to generate a RecoveryObject as described above. As shown, the Challenge Questions screen 500-m includes a drop-down list 550 for a first question with an associated answer input box 551, a drop-down list 552 for a second question with an associated answer input box 553, and a drop-down list 554 for a third question with an associated answer input box 555. According to an embodiment, one or more of the answers entered by the banking client in the input boxes 551, 553 and/or 555 may be used to generate a hash for encrypting the password, for example, as described above with reference to FIG. 2 and the registration process. As shown in FIG. 5(m), the Challenge Questions screen 500-m may include a “Next” button 556 for accessing a Security Image screen 500-n.

The Security Image screen 500-n may have a form as shown in FIG. 5(n) and provides an additional layer of security for preventing unauthorized access to credentials via the desktop agent. According to an embodiment, the Security Image screen 500-n allows the banking client to select an image 560 using an image selection link 562. The banking client enters a name for the image 560 in an input box 564. As part of the logon procedure, the image is presented to the banking client and the banking client confirms the image name to proceed. In known manner, the security image mechanism can be effective against “phishing” which attempts to sign the banking client into a fraudulent service in order to obtain their password and other logon identifiers. In response to the banking client clicking a “Finish” button 566 on the Security Image screen 500-n, the activation wizard displays an Activation Completed screen 500-o having a form as shown in FIG. 5(o). The Activation Completed screen 500-o includes an image 570 which depicts the appearance of a “Secure Alerts” icon 572 that will appear in the “icon tray” on the desktop of the banking client's computer. The Secure Alerts icon 572 is installed in the tray folder on the banking client's computer. The banking client may use the Secure Alerts icon 572 to view any pending alerts (e.g. pending messages, secure document downloads(s)) or to change any of the settings associated with the desktop agent. The banking client exits the activation wizard by clicking an “Exit” button 574.

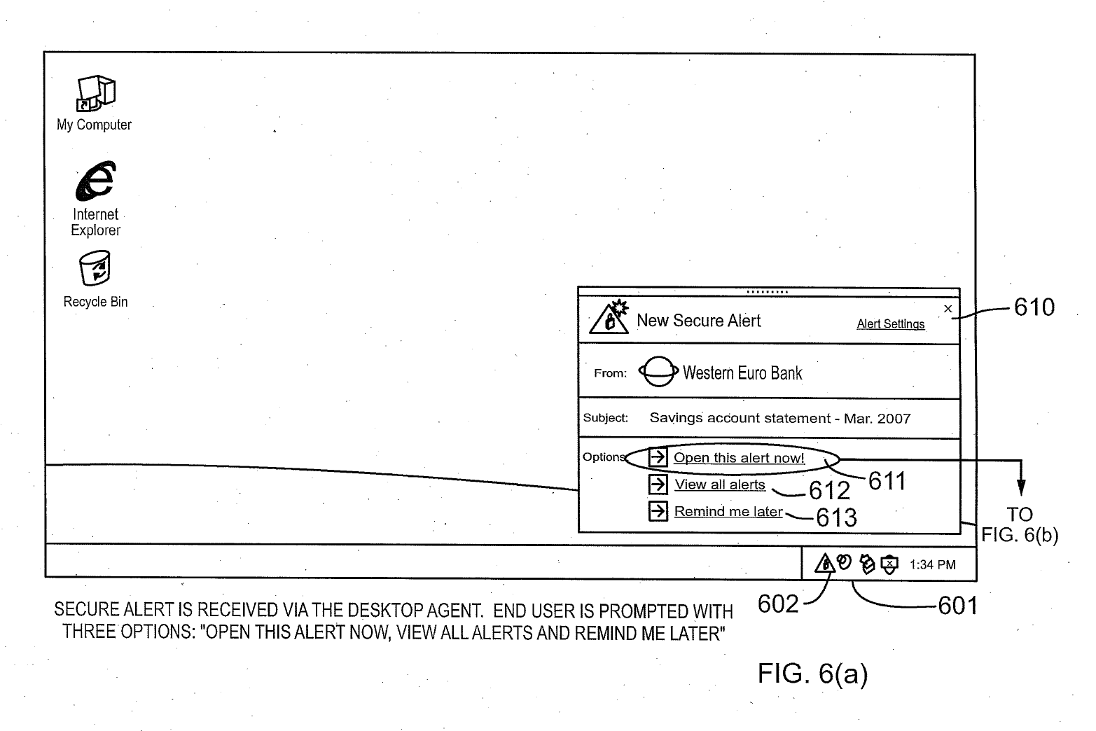

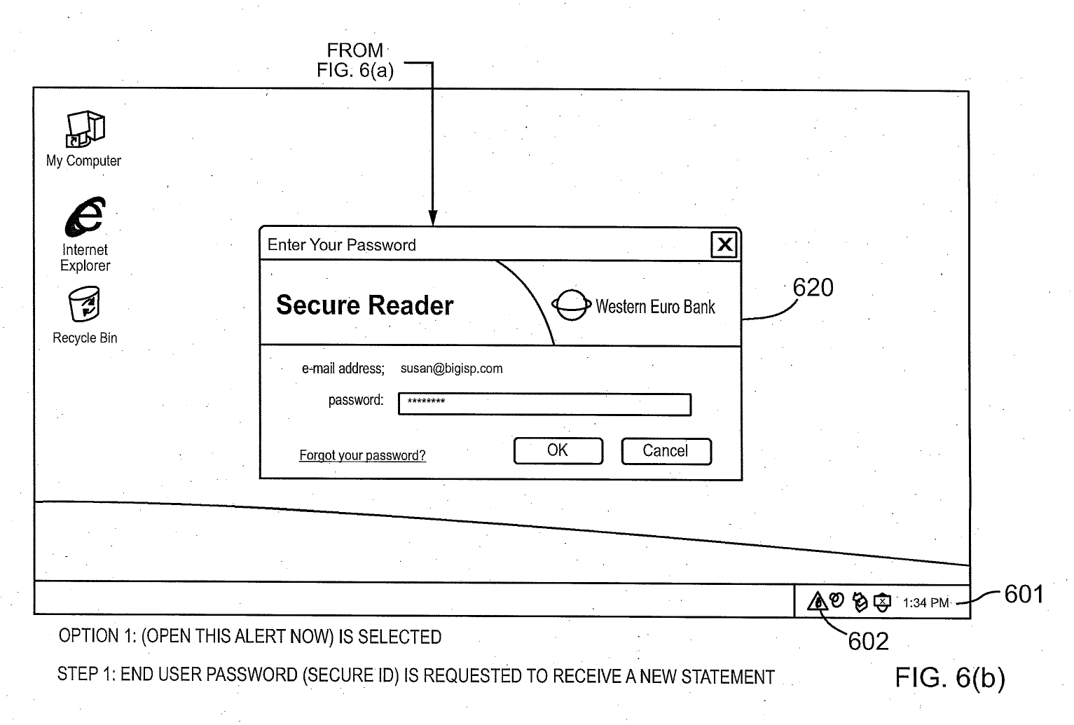

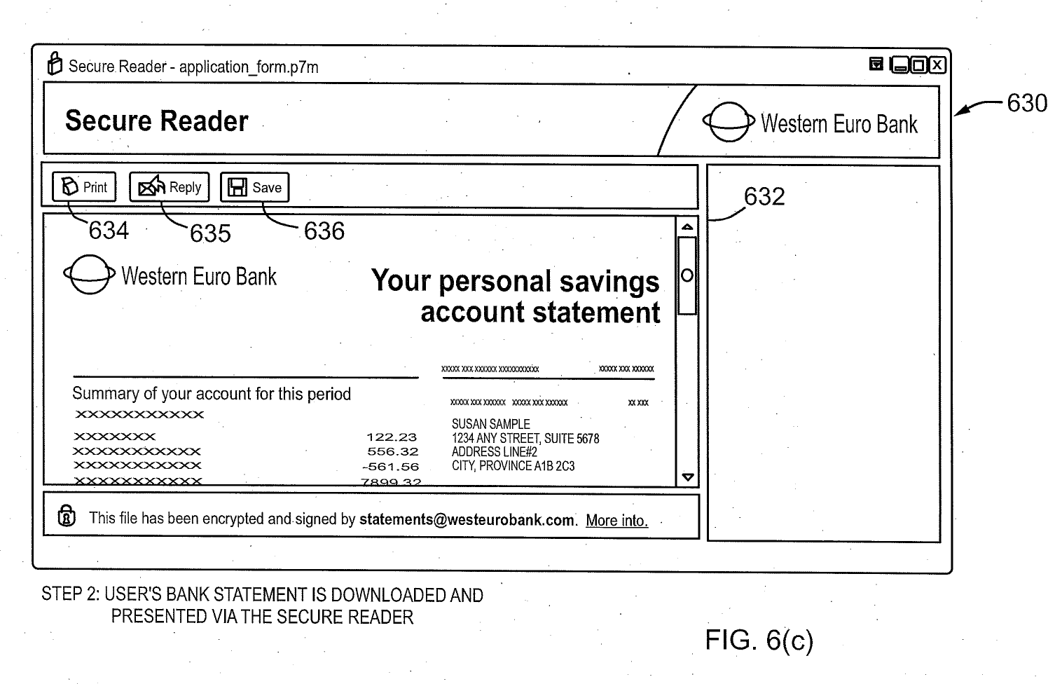

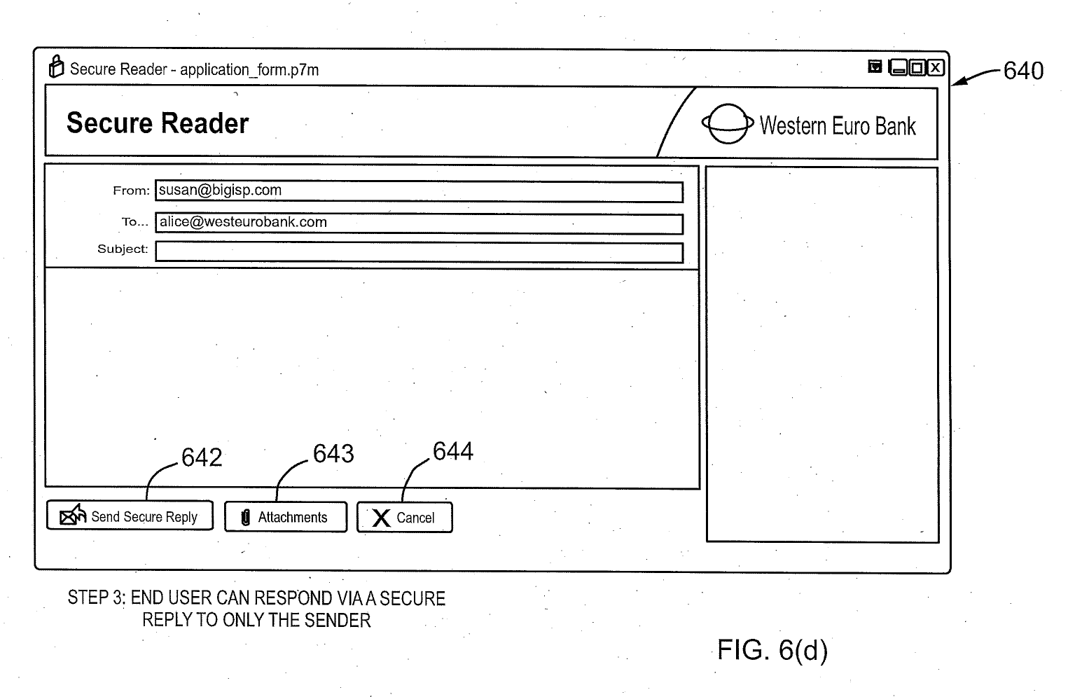

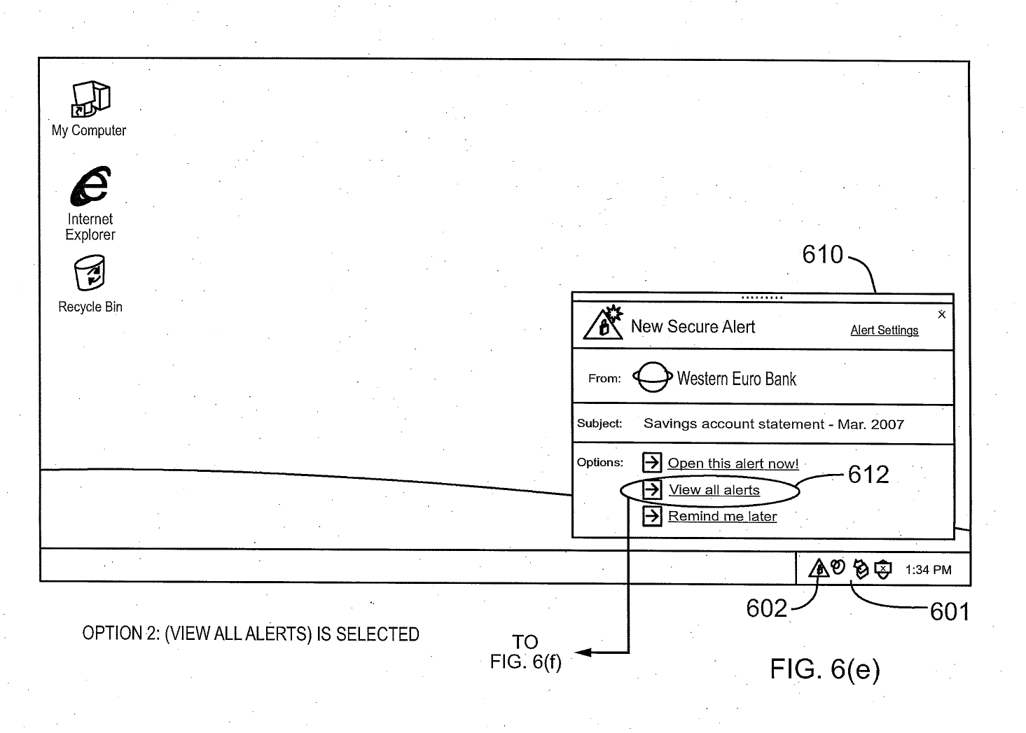

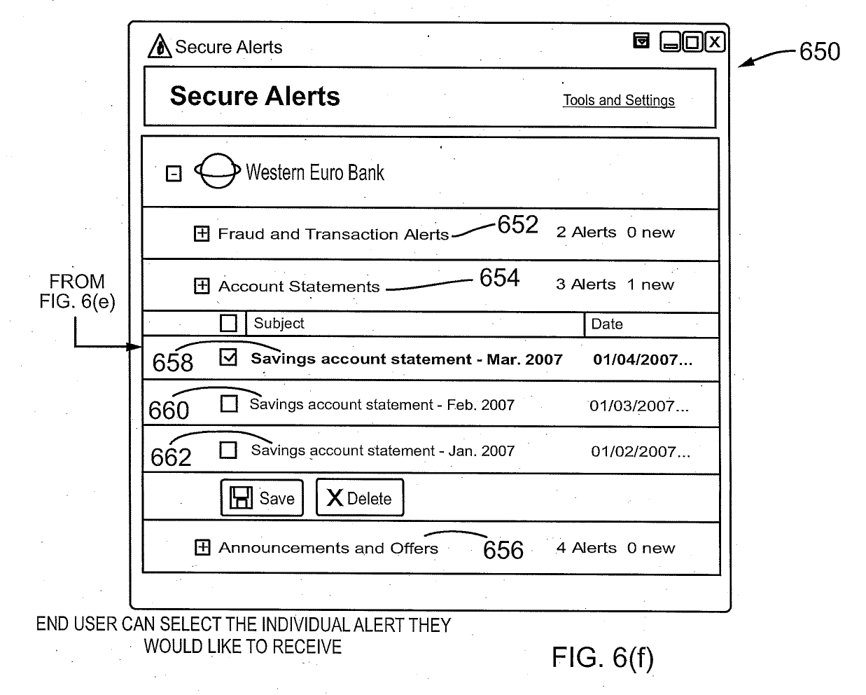

Reference is next made to FIGS. 6(a) to 6(f), which further illustrate operation of the system and method for receiving and opening a secure message alert or notification according to embodiments of the present invention.

Reference is made to FIG. 6(a) which shows a screen shot of a desktop with a ‘pop-up’ window for a new alert notification. According to an embodiment, the application (i.e. the desktop agent) generates the notification in response to a polling operation as described above. The ‘pop-up’ window is indicated generally by reference 610 and is displayed by the desktop agent 144 (FIG. 1) in response to receiving an alert notification 154 (FIG. 1) from the server 110 (FIG. 1), for example as described above. According to an embodiment, the pop-up window 610 includes three options: “Open this alert now!” indicated by reference 611, “View all alerts” indicated by reference 612, and “Remind me later” indicated by reference 613. According to an embodiment, the three options 611, 612, 613 are implemented in the form of HTML links. The “Open this alert now!” option allows the banking client to open/view the current alert (e.g. secure message and/or secure document). The “View all alerts” option allows the banking client to open/view the all the alerts (e.g. secure message). The “Remind me later” option allows the banking client to close the ‘pop-up’ window and continue with what they were doing. The Alert notification icon 602 appearing in the icon tray 601 of the desktop can be flashed or otherwise marked to indicate that there are pending or unread alert notifications.

In response to the banking client clicking the “Open this alert now!” HTML link 611, the application displays an Enter Your Password screen 620 having a form as shown in FIG. 6(b). As shown in FIG. 6(b), the Enter Your Password screen 620 includes an input box 622 for the banking client to enter his or her password and an “OK” button 624 to initiate receipt of the secure message, in this example, the secure message comprises an electronic account statement as shown in FIG. 6(c). FIG. 6(c) shows a screenshot of a Secure Reader screen 630 according to an embodiment. The Secure Reader screen 630 includes a window 632 which displays the electronic account statement, in this example, the account statement for the banking client's personal savings account. The Secure Reader screen 630 includes a “Print” button 634, a “Reply” button 635 and a “Save” button 636. Clicking the Reply button 636 causes the desktop agent to display a compose email screen 640 having a form as shown in FIG. 6(d). As shown, the compose email screen 640 includes a “Send Secure Reply” button 642, an “Attachments” button 643, and a “Cancel” button 644. According to an embodiment, the banking client is restricted to responding to only the sender of the secure document, for example, a contact person (alice@westeurobank.com) at the Western Euro Bank.

Referring next to FIG. 6(e), if the banking client selects (i.e. ‘clicks’) on the View all alerts HTML link 612, then the desktop agent displays an Alerts screen 650 having a form as shown in FIG. 6(f). As shown, the Alerts screen 650 includes a “Fraud and Transaction Alerts” folder 652, an “Account Statements” folder 654, and an “Announcements and Offers” folder 656. The folders 652, 654 and/or 656 may be selected for display according to the preferences in the Alert Preferences screen 500-k described above with reference to FIG. 5(k). As shown in FIG. 6(f), the Account Statements folder 654 has been opened and shows a “Savings account statement—March 2007” indicated by reference 658, a “Savings account statement—February 2007” indicated by reference 660, and a “Savings account statement—January 2007” indicated by reference 662. A “Save” button 664 and a “Delete” button 666 are provided for managing the individual secure documents.

In summary and according to an embodiment of the invention, the secure server 110 obtains the public keys associated with one of clients 130 to encrypt a message, e.g. a document such as bank statement, intended for the client 130. The message is digitally signed and encrypted with a public-private key pair associated with the client 130. The secure server 110 transmits, i.e. “pushes”, an alert (e.g. a “Secure Alert”) to the desktop agent 144. The client 130 has the option of opening the message using the desktop agent 140, viewing the message at a later time, or being redirecting to on-line portal for the enterprise 120. According to an embodiment, the message may comprise or include a confidential or private document, such as a bank statement, a loan application or mortgage document. According to another aspect, the secure document delivery mechanism provides the capability to monitor/track the delivery and receipt of the secure message or document.

According to another aspect, the desktop agent 144 provides a branding facility for the enterprise 120. For example, the enterprise 120 can send dynamic (i.e. real-time) advertising and/or targeted advertising to one or more of the clients 130. In addition to or in the alternative, the various screens associated with the desktop agent may be branded for the enterprise. For example, the New Secure Alert screen 610 (FIG. 6(a)), the Secure Reader screen 630 (FIG. 6(c)) and the Secure Alerts screen 650 (FIG. 6(f)) are branded for the “Western Euro Bank”.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A mechanism for delivering a secure message to the desktop of a computer, said mechanism comprising:
polling means for determining if a secure message is waiting for a user associated with the computer;
means responsive to said polling means for generating a notification for the user if a secure message is waiting;
means responsive to an input from said user for delivering said secure message to the desktop of the computer in a form that is readable by said user.

2. The mechanism as claimed in claim 1, wherein said polling means includes means for establishing a communication link with a server, and said server holding one or more secure messages intended for said user.

3. The mechanism as claimed in claim 2, wherein said means for establishing a communication link comprises means for providing said server with security credentials associated with said user, and said server includes means for authenticating said security credentials.

4. The mechanism as claimed in claim 3, wherein said server includes means responsive to said means for authenticating for providing information associated with said one or more secure messages intended for said user to said polling means, and said means for generating a notification being responsive to said information and generating said notification.

5. The mechanism as claimed in claim 4, wherein said information associated with said one or more secure messages comprises a messages header.

6. The mechanism as claimed in claim 3, wherein said communication link comprises a secure channel.

7. The mechanism as claimed in claim 6, wherein said secure message comprises a message encrypted with a public-private key pair associated with said user.

8. The mechanism as claimed in claim 1, wherein said notification comprises a pop-up window, said pop-up window being displayed on the desktop of the computer.

9. The mechanism as claimed in claim 8, wherein said pop-up window includes means for indicating a plurality of waiting secure messages.

10. The mechanism as claimed in claim 9, wherein said plurality of waiting secure messages comprise one or more groups, and said one or more groups corresponding to preferences set by said user.

11. A method for delivering a secure message to a desktop of a computer associated with a user, said method comprising the steps of:
polling a server to determine if one or more secure messages are waiting for the user;
generating a notification for the user on the desktop of the computer if one or more secure messages are waiting for the user;
delivering at least a portion of said one or more secure messages to the desktop of the computer.

12. The method as claimed in claim 11, wherein said at least a portion of said one or more secure messages comprises a message header for each of said secure messages.

13. The method as claimed in claim 11, wherein said step of delivering comprises delivering a complete copy of said one or more secure messages.

14. The method as claimed in claim 13, wherein said one or more secure messages comprise one or more of an email message, a bank account statement, a brokerage account statement, a loan application, a mortgage document, or a confidential document.

15. The method as claimed in claim 11, wherein said step of polling comprises establishing a communication link with said server, providing one or more security credentials associated with the user, and authenticating said one or more security credentials.

16. The method as claimed in claim 15, wherein said step of generating a notification is responsive to the authentication of said one or more security credentials.

17. The method as claimed in claim 16, further including providing a message link in said notification, said message link being responsive to an input from the user for initiating delivery of said secure message.

18. The method as claimed in claim 17, wherein said step of delivering includes encrypting said one or more secure messages with a public-private key pair associated with the user.

19. The method as claimed in claim 18, wherein said communication link comprises a secure channel.
